(19) United States
(12) Patent Application Publication
(10) Pub. No.: US 2025/0259226 A1
(43) Pub. Date: Aug. 14, 2025

(54) USING A TRAINED MODEL OF AN ONLINE SYSTEM FOR POST-DELIVERY EFFORT-BASED TIP INCREASE RECOMMENDATION

(71) Applicant: Maplebear Inc., San Francisco, CA (US)

(72) Inventor: Naval Shah, Toronto (CA)

(21) Appl. No.: 18/438,261

(22) Filed: Feb. 9, 2024

(51) Int. Cl. G06Q 30/0601; G06Q 10/083

(52) U.S. Cl. CPC G06Q 30/0635; G06Q 10/083

(57) ABSTRACT

A trained model is used to generate a post-delivery effort-based tip increase recommendation for a user of an online system. The online system applies the computer model to predict, based on information about an original order placed by the user and data describing an effort required to fulfill the order, a tip amount that is likely to lead to satisfaction of a picker associated with the online system who fulfilled the order. Responsive to information about a sentiment of the user in relation to the fulfillment process, the online system generates, based on the predicted tip amount and an original tip amount provided by the user before the fulfillment process for the order was completed, a tip adjustment amount. The online system causes a user interface of a device associated with the user to display the tip adjustment amount prompting the user to adjust the original tip amount.

### BACKGROUND

Users of online systems, such as online concierge systems, can provide tips (i.e., gratitude monetary amounts) to pickers who perform shopping and delivering of ordered items. Typically, a user of an online system adds a tip amount for a picker before fulfillment (i.e., at the time when an order was placed), but they also have the opportunity to adjust the tip amount after the fulfillment. Traditionally, the online systems set the tip recommendations/defaults based on a monetary value (i.e., price) associated with an order, but the order's price may be inconsistent with the difficulty and/or effort in fulfilling the order. Therefore, it is desirable to optimize tip amounts based on efforts by pickers in fulfilling orders. However, as tipping is highly subjective, there is a technical problem of how to determine an effort in fulfilling an order without human review—i.e., how to automate at a large scale the determination of optimal tip amounts for different efforts in fulfilling various orders.

### SUMMARY

Embodiments of the present disclosure are directed to using a trained computer model to generate a post-delivery, effort-based tip increase recommendation for a user of an online system (e.g., online concierge system).

In accordance with one or more aspects of the disclosure, the online system obtains order data with information about an order placed by a user of an online system. The online system gathers fulfillment data describing a fulfillment process for the order. The online system accesses a tip prediction computer model of the online system, wherein the tip prediction computer model is trained to predict a tip amount that is likely to lead to satisfaction of a picker associated with the online system who fulfilled the order. The online system applies the tip prediction computer model to predict, based on the order data and the fulfillment data, the tip amount. The online system identifies information about a sentiment of the user in relation to the fulfillment process. The online system receives information about an original tip amount the user provided for fulfilling the order before the fulfillment process for the order was completed. Responsive to the information about the sentiment of the user, the online system generates, based on the predicted tip amount and the original tip amount, a tip adjustment amount. The online system causes a user interface of a device associated with the user to display the tip adjustment amount prompting the user to adjust the original tip amount to at least the predicted tip amount.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example architectural flow diagram of using a trained computer model to generate a post-delivery effort-based tip increase recommendation for a user of an online concierge system, in accordance with one or more embodiments.

FIG. 4A illustrates an example user interface of a device associated with a user of an online concierge system with a message that prompts a response from the user about the user's satisfaction in relation to an order fulfillment process, in accordance with one or more embodiments.

FIG. 4B illustrates an example user interface of a user client device with a post-delivery effort-based tip adjustment recommendation for a user of an online concierge system, in accordance with one or more embodiments.

FIG. 5 is a flowchart for a method of using a trained computer model to generate a post-delivery effort-based tip adjustment recommendation for a user of an online concierge system, in accordance with one or more embodiments.

### DETAILED DESCRIPTION

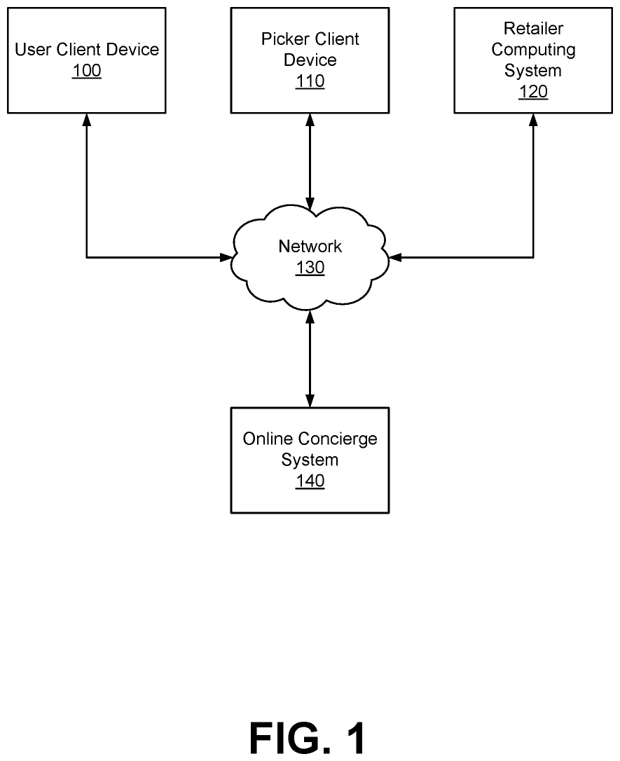

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user.

The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 enables users to place orders for goods or services, which are fulfilled by pickers. A user interface at the user client device 100 that a user of the online concierge system 140 uses to place an order provides a mechanism for the user to tip a picker associated with the online concierge system 140 who fulfills the order, such as when placing the order and adding or adjusting a tip amount after the order is fulfilled. When the user sets a tip amount for an order ahead of time before the order is fulfilled and even before the order is accepted by the picker, this is done before the picker or the user knows exactly how much effort and work would be involved in fulfilling the order. There are many unknowns at the time the order is placed that are known only after the order is fulfilled. For example, once the order has been delivered, the online concierge system 140 has the knowledge about how long it took to fulfill the order, how many replacements were made, how much communication took place between the user and the picker, how bad traffic was for the picker to deliver the order, etc. This presents an opportunity for the online concierge system 140 to guide the user in increasing their tip accordingly based on information about fulfillment related to an effort by the picker that was required to fulfill the order, and similarly it is an opportunity to increase picker tips and their fairness.

To enable the user to provide a reasonable tip after the order is fulfilled, which is based on the actual effort required by the picker to fulfill the order, the online concierge system 140 uses a trained model (e.g., machine-learning computer model) to determine the reasonable tip based on input features that relate to the effort required by the picker to fulfill the order. After the order has been fulfilled, in order to determine a suggested tip amount, the online concierge system 140 applies the trained model to a set of inputs that include information about the fulfillment that relate to the required effort by the picker to fulfill the order. The online concierge system 140 may then prompt the user to set a tip amount, or increase a previous tip amount, along with providing reasons why a larger tip might be appropriate given the effort involved in the order fulfillment. This can increase picker satisfaction, both picker and user perception of fairness, picker tips, and picker retention rates.

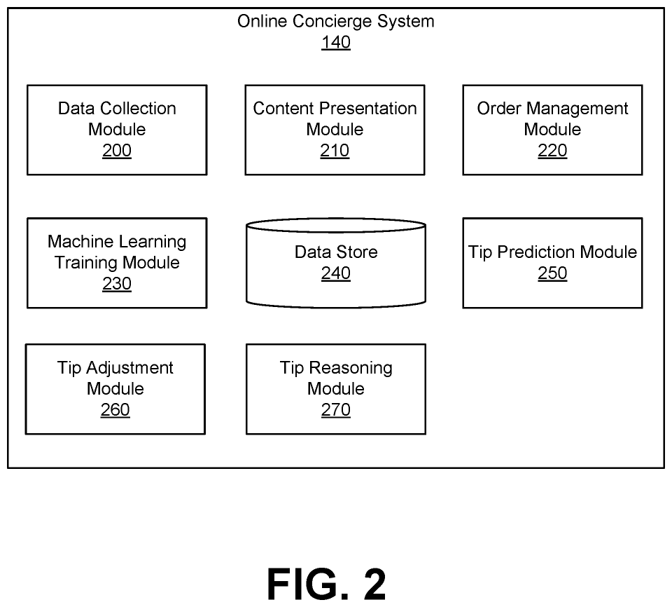

The online concierge system 140 presented herein thus applies the trained model to generate an effort-based tip increase recommendation for a specific order placed by a user of the online concierge system 140. Once the order is fulfilled, there is plenty of clear data that the trained model can utilize to calculate an optimal effort-based tip amount for recommendation to the user. Note that although the trained model calculates the effort-based tip increase recommendation for the user, the online concierge system 140 still maintains full flexibility in determining how and when to present the effort-based tip increase recommendation to the user at a user interface of the user client device 100. For example, if the user rated the picker very poorly, the online concierge system 140 would not nudge the user to add to their previously set tip amount, and vice versa if the user rates their picker's work highly, the online concierge system 140 may use that as an opportunity to present the updated effort-based tip increase recommendation at the user interface of the user client device 100. The online concierge system 140 is described in further detail below with regards to FIG. 2.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, a tip prediction module 250, a tip adjustment module 260, and a tip reasoning module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may re-train the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The tip prediction module 250 may determine a suggested tip amount a user of the online concierge system 140 should provide for fulfilling an order after a fulfillment process is completed, where the suggested tip amount is determined based on information about an effort required to fulfill the order. The tip prediction module 250 may access a tip prediction computer model (e.g., machine-learning computer model) that is trained to predict a tip amount that is likely to lead to satisfaction of a picker associated with the online concierge system 140 who fulfilled the order, given an effort that was required to fulfill the order. The tip prediction module 250 may deploy the tip prediction computer model to run a machine-learning algorithm to predict, based on a set of inputs, the tip amount that is likely to satisfy the picker, given the effort required to fulfill the order. Thus, an output of the tip prediction computer model may be the tip amount that the picker would consider fair, given the effort required to fulfill the order. In one or more embodiments, once the fulfillment process for the order is completed (or at least until after a phase of the fulfillment process from which the input features are obtained is completed), the tip prediction module 250 applies the tip prediction computer model to compute the effort-based post-fulfillment tip amount. A set of parameters for the tip prediction computer model may be stored at one or more non-transitory computer-readable media of the tip prediction module 250. Alternatively, the set of parameters for the tip prediction computer model may be stored at one or more non-transitory computer-readable media of the data store 240.

The tip prediction module 250 may provide the set of inputs to the tip prediction computer model. The set of inputs may include two types of data. First, in providing the set of inputs to the tip prediction computer model, the tip prediction module 250 may provide data with information about an original order placed by a user of the online concierge system 140, such as features of items requested by the user in the original order, a number of items in the original order, a size of items in the original order, etc. For example, the order management module 220 may gather the information about the original order and provide the gathered information to the tip prediction module 250. The information about the original order may also include information about an original tip set by the user at the time the order was placed. Second, in providing the set of inputs to the tip prediction computer model, the tip prediction module 250 may provide data describing a fulfillment process for the order (e.g., after the delivery is made). The data describing the fulfillment process may be gathered by the order management module 220 during the fulfillment process and provided to the tip prediction module 250.

The data describing the fulfillment process may include various signals related to the fulfillment process that are provided as inputs to the tip prediction computer model. In one or more embodiments, the data describing the fulfillment process include information about a process of picking items at a location of a retailer associated with the online concierge system 140. The information about the process of picking items may include information about a time required to pick the items at the location of the retailer, information about weights of picked items, information about sizes of picked items, information about any custom item that has been picked (e.g., produce, meat, etc.), information about whether any new item has been added to the order during the picking process (e.g., added by the user after the original tip amount was set), information about a number of replacements that the picker needs to make during the picking process, etc. For example, the number of replacements indicates a number of times that the picker needs to first look for another item and not find that item, which requires an additional effort by the picker. In one or more embodiments, the tip prediction computer model is trained to calculate, based on the information about the process of picking items, an effort rating per picked item. The tip prediction computer model may then use the calculated effort rating per picked item along with one or more other input signals related to the effort required to fulfill the order to predict an effort-based post-fulfillment tip amount for recommendation to the user.

Alternatively or additionally, the data describing the fulfillment process may include picker related data. The picker related data may include data related to communication between the picker and the user (i.e., between the picker client device 110 and the user client device 100), such as a number of messages exchanged between the picker and the user, a total time between messages (which may indicate picker's waiting and/or thinking time), a number of pictures taken by the picker and shared with the user, etc. The picker related data may further include checkout data with information about a time spent by the picker at the checkout at the location of the retailer. The picker related data may be communicated from the picker client device 110 via the network 130 to the order management module 220. The order management module 220 may then provide the picker related data to the tip prediction module 250.

Alternatively or additionally, the data describing the fulfillment process may include delivery related data. The delivery related data may include information about a traffic from the location of the retailer to a delivery address of the user (e.g., information on whether there was a particularly bad traffic from the location of the retailer to the delivery address), information about a driving time from the location of the retailer to the delivery address, information about a weather event during the delivery (e.g., information on whether there was any particularly bad weather, such as unforeseen snowfall or rain). The delivery related data may be gathered by the order management module 220 (e.g., by tracking the picker client device 110) and then provided to the tip prediction module 250.

Alternatively or additionally, the data describing the fulfillment process may include drop-off related data. The drop-off related data may include information about a type of drop-off performed by the picker, such as information on whether the drop-off occurred in an apartment complex, information on whether the drop-off was hands-free on a porch, information on whether the drop-off was hands-free in a lobby, information on whether there was elevator to take during the drop-off, information on whether there was a buzzer to use to enter a user's premises, information on whether there were stairs to climb, information about an amount of walking conducted by the picker during the drop-off, some other drop-off related information, or some combination thereof. The drop-off related data may further include information about a number of bags that were delivered by the picker. The drop-off related data may be communicated from the picker client device 110 via the network 130 to the order management module 220 and/or gathered by the order management module 220 by tracking the picker client device 110. The order management module 220 may then provide the drop-off related data to the tip prediction module 250.

The tip adjustment module 260 may determine a tip adjustment amount for suggestion to the user. The tip adjustment module 260 may receive information about an original tip amount the user provided for fulfilling the order before the fulfillment process for the order was completed, e.g., at the time the original order was placed. Information about the original tip amount may be communicated to the tip adjustment module 260 from the user client device 100 via the network 130. Furthermore, the tip adjustment module 260 may determine information about a sentiment (e.g., satisfaction) of the user in relation to the fulfillment process. In one or more embodiments, the tip adjustment module 260 triggers the content presentation module 210 to cause a user interface of the user client device 100 to display a message prompting the user to provide feedback with information about a level of satisfaction by the user in relation to the fulfillment process. Based on the feedback from the user about the user's level of satisfaction in relation to the fulfillment process, the tip adjustment module 260 may determine information about the sentiment of the user in relation to the fulfillment process. Responsive to the information about the sentiment of the user (e.g., upon determining that the user is satisfied with the fulfillment process), the tip adjustment module 260 may determine, based on the tip amount predicted by the tip prediction computer model and the original tip amount, the tip adjustment amount for suggestion to the user.

The tip reasoning module 270 may generate a message for the user that includes reasoning for the suggested increased tip adjustment amount. More specifically, the tip reasoning module 270 may generate a message for the user explaining one or more causes associated with a higher-than-average effort required to fulfill the order. The causes may relate to the data describing the fulfillment process used as inputs into the tip prediction computer model that drive the higher suggested tip amounts generated by the tip prediction computer model. The tip reasoning module 270 may utilize a rules-based system that determines, based on the data describing the fulfillment process, what message to include along with the suggested increased tip adjustment. In one or more embodiments, the tip reasoning module 270 applies a set of rules to the data describing the fulfillment process to select a message from a collection of messages stored at, e.g., the data store 240. The selected message would illustrate to the user that the online concierge system 140 is not blindly generating a tip adjustment recommendation, but rather the tip adjustment recommendation is being suggested to the user based on metrics that the user themselves can understand, such as one or more reasons why the additional effort was required to fulfill the order.

The content presentation module 210 may cause a user interface of the user client device 100 to display a message prompting the user to provide feedback with information about a level of satisfaction by the user in relation to the fulfillment process. If the user was satisfied with the fulfillment process and if the predicted tip amount generated by the tip prediction computer model is higher than the original tip amount, the content presentation module 210 may cause the user interface of the user client device 100 to display the tip adjustment amount (e.g., as received from the tip adjustment module 260). The content presentation module 210 may further cause the user interface of the user client device 100 to display, along with the suggested adjustment tip amount, a message explaining one or more causes associated with higher-than-average effort required to fulfill the order. The user may then utilize the user interface of the user client device 100 to adjust the original tip amount by the suggested tip adjustment amount to match at least the tip amount predicted by the tip prediction computer model. Alternatively, the user may choose not to accept the suggested tip adjustment.

The machine-learning training module 230 may perform initial training of the tip prediction computer model. In one or more embodiments, the machine-learning training module 230 gathers (e.g., from the data store 240) information about a set of tip adjustment amounts for a set of orders placed at the online concierge system 140 during a defined time period (e.g., two weeks, one month, six months, etc.), as well as information about sentiments of a group of pickers who fulfilled the set of orders in relation to the set of tip adjustment amounts. The machine-learning training module 230 may generate training data using the information about the set of tip adjustment amounts and the information about sentiments. The machine-learning training module 230 may train the tip prediction computer model using the generated training data to generate an initial set of parameters of the tip prediction computer model.

In one or more other embodiments, the machine-learning training module 230 may gather training data by collecting survey responses from a group of pickers associated with the online concierge system 140 about whether a set of tip amounts would be fair given the effort required for fulfilling a set of orders placed at the online concierge system 140. The machine-learning training module 230 may train the tip prediction computer model using the gathered training data to generate an initial set of parameters of the tip prediction computer model.

Furthermore, the machine-learning training module 230 may collect feedback data with information about a response by the user in relation to the tip adjustment amount that is displayed at the user interface of the user client device 100. The machine-learning training module 230 may re-train the tip prediction computer model by updating the set of parameters of the tip prediction computer model using the collected feedback data. Alternatively or additionally, the machine-learning training module 230 may collect feedback data from the picker (e.g., as provided by the picker via a user interface of the picker client device 100) with information about a sentiment of the picker in relation to a tip amount provided by the user, i.e., information on whether the picker believes the tip amount reflected their effort in fulfilling the order. The machine-learning training module 230 may re-train the tip prediction computer model by updating, using the collected feedback data with information about the picker's level of satisfaction in relation to the tip amount, the set of parameters of the tip prediction computer model.

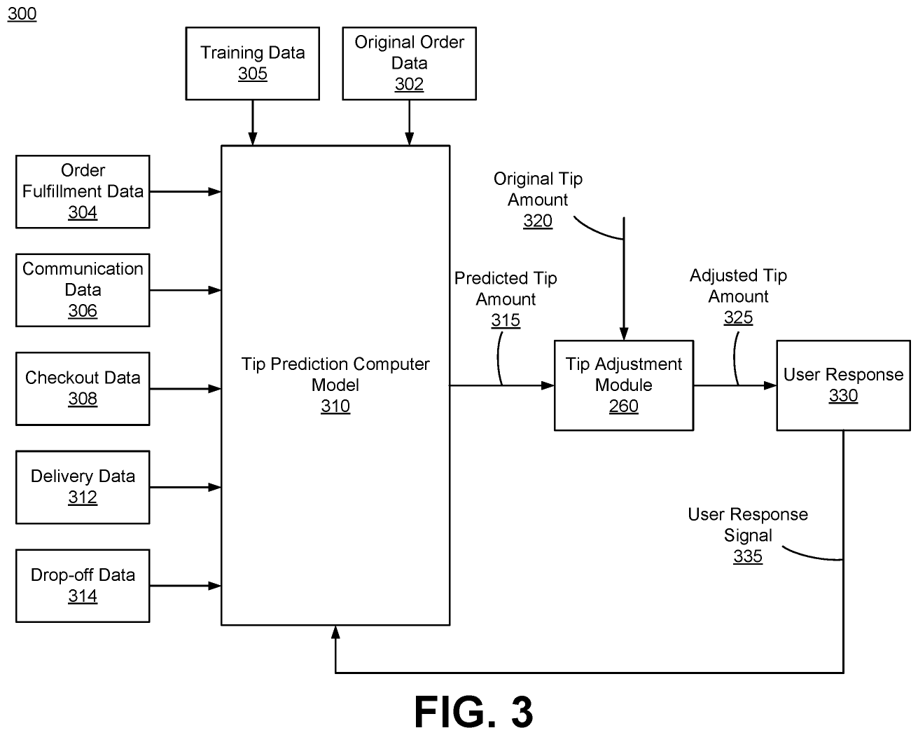

FIG. 3 illustrates an example architectural flow diagram 300 of using a tip prediction computer model 310 to generate a post-delivery effort-based tip increase recommendation for a user of the online concierge system 140, in accordance with one or more embodiments. First, the online concierge system 140 may perform (e.g., via the machine-learning training module 230) initial training of the tip prediction computer model 310 using training data 305 to generate an initial set of parameters of the tip prediction computer model 310. The training data 305 may be generated by gathering (e.g., via the machine-learning training module 230) information about a set of tip adjustment amounts for a set of orders placed at the online concierge system 140 during a defined time period, as well as information about sentiments of a group of pickers who fulfilled the set of orders in relation to the set of tip adjustment amounts.

After the training process is completed, the online concierge system 140 may provide original order data 302 to the tip prediction computer model 310. The original order data 302 may include information about types of items requested by the user in the original order, a number of items in the original order, a size of items in the original order, an original tip amount set by the user before an order fulfillment process started, etc. The original order data 302 may be gathered by the order management module 220 and provided to the tip prediction computer model 310.

In addition to the original order data 302 collected before the start of the order fulfillment process, various data collected during the order fulfillment process are input to the tip prediction computer model. For example, the online concierge system 140 may provide order fulfillment data 304 to the tip prediction computer model 310. In providing the order fulfillment data 304 to the tip prediction computer model 310, the online concierge system 140 may provide information about a time required for a picker to pick the items at a location of a retailer, information about weights of picked items, information about sizes of picked items, information about any custom item that has been picked (e.g., produce, meat, etc.), information about whether any new item has been added to the order during the picking process (e.g., added by the user after the original tip amount was set), information about a number of replacements that the picker needs to make during the picking process, etc. The order fulfillment data 304 may be gathered by the order management module 220 during the fulfillment process and provided to the tip prediction computer model 310.

The online concierge system 140 may further provide communication data 306 to the tip prediction computer model 310. The communication data 306 may include data communicated between the picker and the user, i.e., between the picker client device 110 and the user client device 100. For example, the communication data 306 may include a number of messages exchanged between the picker and the user, a total time between messages, a number of pictures taken by the picker and shared with the user, etc. The communication data 306 may be communicated from the picker client device 110 via the network 130 to the order management module 220, which can be then provided to the tip prediction computer model 310.

The online concierge system 140 may further provide checkout data 308 to the tip prediction computer model 310. The checkout data 308 may include information about a time spent by the picker at the checkout at the location of the retailer. The checkout data 308 may be communicated from the picker client device 110 via the network 130 to the order management module 220, which can be then provided to the tip prediction computer model 310.

The online concierge system 140 may further provide delivery data 312 to the tip prediction computer model 310. The delivery data 312 may include information about a traffic from the location of the retailer to a delivery address of the user, information about a driving time from the location of the retailer to the delivery address, information about weather during the delivery, etc. The delivery data 312 may be gathered by the order management module 220 (e.g., by tracking the picker client device 110) and then provided to the tip prediction computer model 310.

The online concierge system 140 may further provide drop-off data 314 to the tip prediction computer model 310. The drop-off data 314 may include information about a type of drop-off performed by the picker, a complexity of the drop-off, a number of bags that were delivered by the picker, and any other information about an effort made by the picker to drop-off the picked items. The drop-off data 314 may be communicated from the picker client device 110 via the network 130 to the order management module 220 and/or gathered by the order management module 220 by tracking the picker client device 110. The order management module 220 may then provide the drop-off data 314 to the tip prediction computer model 310.

The tip prediction computer model 310 may predict, based on a set of inputs, a post-delivery effort-based tip amount 315. The set of inputs may include the original order data 302, the order fulfillment data 304, the communication data 306, the checkout data 308, the delivery data 312, and/or the drop-off data 314. The predicted tip amount 315 may be passed along with an original tip amount 320 to the tip adjustment module 260. The tip adjustment module 260 may compute, based on the predicted tip amount 315 and the original tip amount 320, an adjusted tip amount 325 for recommendation to the user.

Upon determination that the user is satisfied with the order fulfillment process, the adjusted tip amount 325 may be suggested to the user, e.g., via a user interface of the user client device 100. A user response 330 in relation to the adjusted tip amount 325 may be recorded as a user response signal 335. The user response signal 335 may indicate that the user accepted the suggested adjusted tip amount 325. Alternatively, the user response signal 335 may indicate that the user did not accept the suggested adjusted tip amount 325, e.g., the user selected smaller than the suggested adjusted tip amount 325 or did not adjust at all the original tip amount 320. The user response signal 335 may be utilized by the machine-learning training module 230 to re-train the tip prediction computer model 310 in order to continuously improve the set of parameters of the tip prediction computer model 310 to provide an optimal predicted tip amount 315 for a given user and for a specific order fulfillment process.

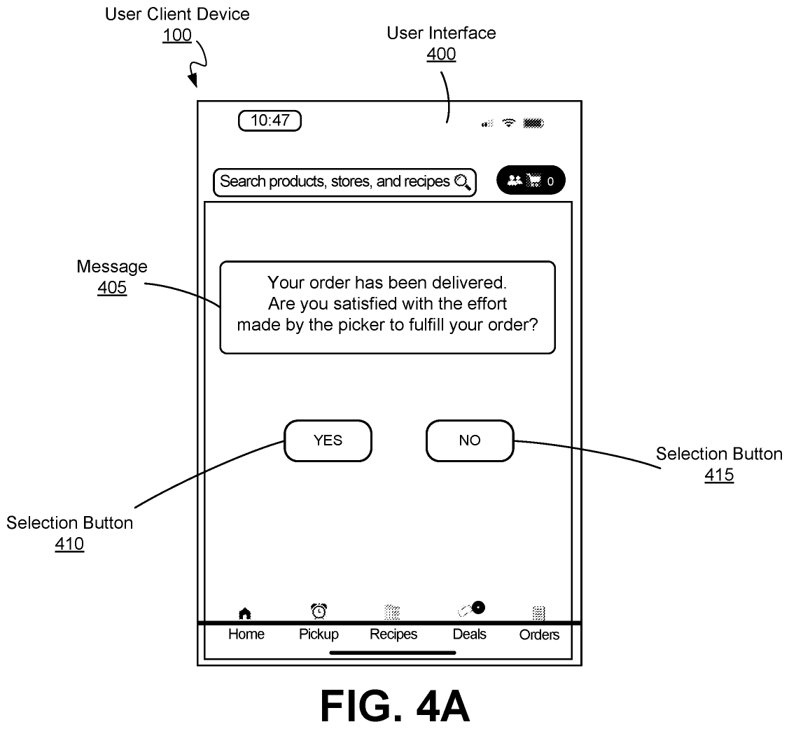

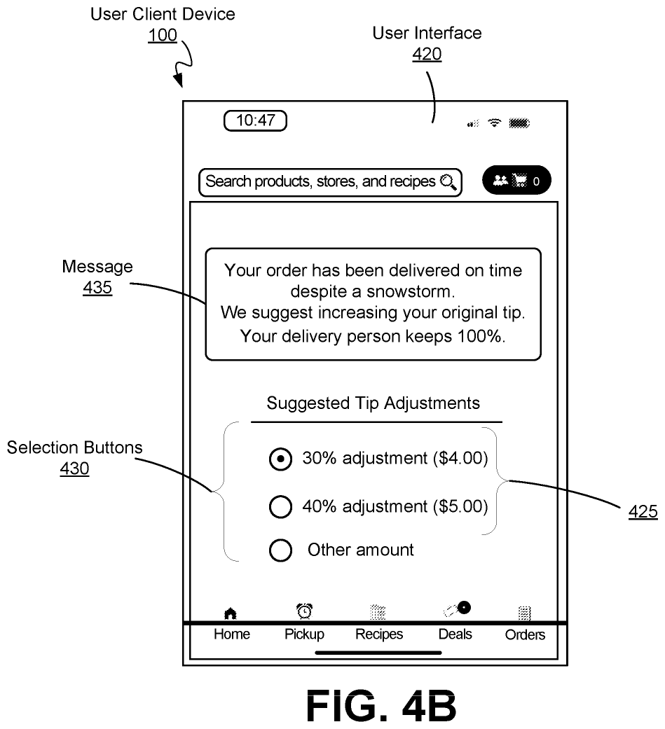

FIG. 4A illustrates an example user interface 400 of the user client device 100 with a message 405 for a user of the online concierge system 140 that prompts a response from the user about the user's satisfaction in relation to an order fulfillment process, in accordance with one or more embodiments. The user interface 400 may be displayed after the order fulfillment process is completed, i.e., once a picker associated with the online concierge system delivers items to a delivery location of the user. The user may utilize corresponding selection buttons 410, 415 to provide information about their sentiment in relation to an effort made by the picker to fulfill the order. If the user presses the selection button 410 indicating their satisfaction in relation to an effort made by the picker to fulfill the order, a new user interface 420 would be displayed at the user client device, as shown in FIG. 4B.

FIG. 4B illustrates an example user interface 420 of the user client device with an effort-based post-fulfillment tip adjustment recommendation for the user, in accordance with one or more embodiments. Based on an output of the tip prediction computer model and the original tip amount set by the user, the content presentation module 210 may cause the user client device 100 to display the user interface 420 with one or more suggested tip adjustments 425. For example, the suggested tip adjustments 425 include a suggested tip adjustment amount (e.g., “30% adjustment ($4.00)”) determined based on a post-delivery effort-based tip amount generated by the tip prediction computer model. Additionally, the suggested tip adjustments 425 include an option for the user to be even more generous and adjust an original tip amount by a higher adjustment value (e.g., “40% adjustment ($5.00)”). The suggested tip adjustments 425 also include an option for the user to select their own tip adjustment amount. The user may utilize one of multiple selection buttons 430 to select the appropriate tip adjustment. The user's selection of the tip adjustment may be used (e.g., by the machine-learning training module 230) for re-training of the tip prediction computer model. The content presentation module 210 may further cause the user client device 100 to display the user interface 420 with a message 435. The message 435 may be generated by the tip reasoning module based on a set of inputs provided to the tip prediction computer model. The message 435 explains to the user one or more causes associated with a higher-than-average effort required to fulfill the order.

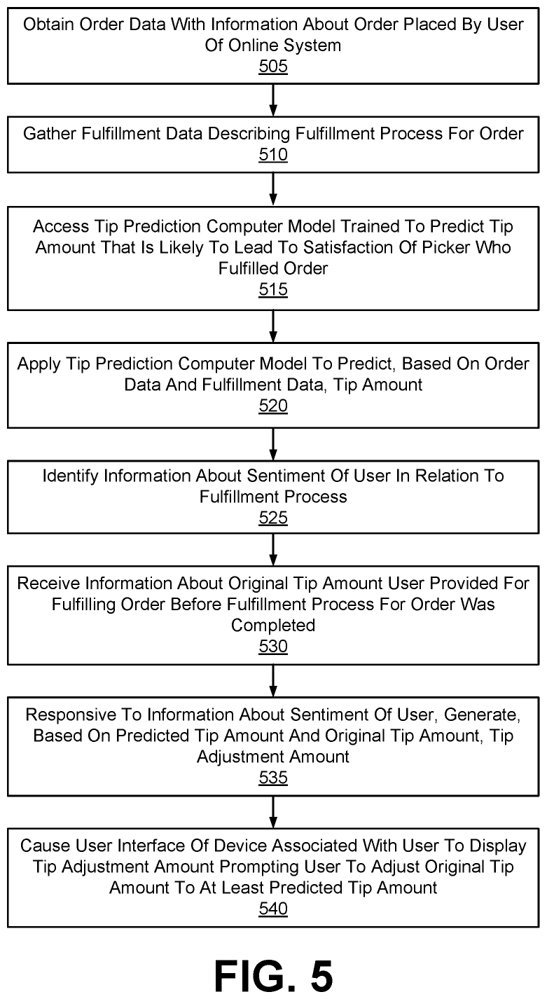

FIG. 5 is a flowchart for a method of using trained computer models to generate a post-delivery effort-based tip adjustment recommendation for a user of an online concierge system, in accordance with one or more embodiments. Alternative embodiments may include more, fewer, or different steps from those illustrated in FIG. 5, and the steps may be performed in a different order from that illustrated in FIG. 5. These steps may be performed by an online concierge system (e.g., the online concierge system 140). Additionally, each of these steps may be performed automatically by the online concierge system without human intervention.

The online concierge system 140 obtains 505 (e.g., via the order management module 220) order data with information about an order placed by a user of the online concierge system 140. The online concierge system 140 gathers 510 (e.g., via the order management module 220) fulfillment data describing a fulfillment process for the order.

The online concierge system 140 may receive (e.g., via the order management module 220), from a device associated with the user (e.g., from the user client device 100) via a network (e.g., the network 130), information about a set of items that were originally ordered by the user. The online concierge system 140 may further receive (e.g., via the order management module 220), from a device associated with a picker (e.g., the picker client device 110) via the network, at least one of: a set of features for a set of items picked by the picker at a location of a retailer associated with the online concierge system 140, information about a time the picker spent on checking-out at the location of the retailer, or information about an effort made by the picker during a drop-off phase of the fulfillment process.

The online concierge system 140 may further receive (e.g., via the order management module 220), via the network, at least one of information about a traffic during delivery of the order to a delivery location of the user, or information about a weather event during delivery of the order to the delivery location. Additionally or alternatively, the online concierge system 140 may receive (e.g., via the order management module 220), from at least one of the device associated with the user or the device associated with the picker via the network, at least one of: information about a number of items from an original set of items associated with the order that were replaced during the fulfillment process, information about a new items that were added to the order during the fulfillment process, or communication data exchanged between the device associated with the user and the device associated with the picker during the fulfillment process.

The online concierge system 140 accesses 515 a tip prediction computer model of the online concierge system 140 (e.g., via the tip prediction module 250), wherein the tip prediction computer model is trained to predict a tip amount that is likely to lead to satisfaction of a picker associated with the online concierge system 140 who fulfilled the order. The online concierge system 140 applies 520 the tip prediction computer model (e.g., via the tip prediction module 250) to predict, based on the order data and the fulfillment data, the tip amount.

In one or more embodiments, the online concierge system 140 gathers (e.g., via the machine-learning training module 230) information about a set of tip adjustment amounts for a set of orders placed at the online concierge system 140 during a defined time period. The online concierge system 140 may also gather (e.g., via the machine-learning training module 230) information about sentiments of a group of pickers associated with the online concierge system 140 in relation to the set of tip adjustment amounts. The online concierge system 140 may then generate (e.g., via the machine-learning training module 230) training data using the information about the set of tip adjustment amounts and the information about sentiments. The online concierge system 140 may train (e.g., via the machine-learning training module 230) the tip prediction computer model using the generated training data to generate an initial set of parameters of the tip prediction computer model.

In one or more other embodiments, the online concierge system 140 gathers (e.g., via the machine-learning training module 230) training data by surveying a group of pickers associated with the online concierge system 140 about a set of tip amounts for a set of fulfillment processes associated with a set of orders placed at the online system. The online concierge system 140 may train (e.g., via the machine-learning training module 230) the tip prediction computer model using the gathered training data to generate an initial set of parameters of the tip prediction computer model.

The online concierge system 140 identifies 525 (e.g., via the tip adjustment module 260) information about a sentiment of the user in relation to the fulfillment process. The online concierge system 140 may cause (e.g., via the content presentation module 210) a user interface of a device associated with the user (e.g., the user client device 100) to display a message prompting the user to provide feedback with information about a level of satisfaction by the user in relation to the fulfillment process. The online concierge system 140 may identify (e.g., via the tip adjustment module 260), based on the information about the level of satisfaction, the information about the sentiment of the user in relation to the fulfillment process. The online concierge system 140 receives 530 (e.g., via the order management module 220) information about an original tip amount the user provided for fulfilling the order before the fulfillment process for the order was completed. Responsive to the information about the sentiment of the user, the online concierge system 140 generates 535 (e.g., via the tip adjustment module 260), based on the predicted tip amount and the original tip amount, a tip adjustment amount.

The online concierge system 140 causes 540 (e.g., via the content presentation module 210) a user interface of a device associated with the user (e.g., the user client device 100) to display the tip adjustment amount prompting the user to adjust the original tip amount to at least the predicted tip amount. The online concierge system 140 may generate (e.g., via the tip reasoning module 270), based on the order data and the fulfillment data, a message explaining an effort made by the picker during the fulfillment process. The online concierge system 140 may cause (e.g., via the content presentation module 210) the user interface of the device associated with the user to further display the generated message along with the tip adjustment amount.

The online concierge system 140 may collect (e.g., via the machine-learning training module 230) feedback data with information about a response by the user in relation to the tip adjustment amount that is displayed at the user interface of the device associated with the user. The online concierge system 140 may re-train (e.g., via the machine-learning training module 230) the tip prediction computer model by updating, using the collected feedback data, the set of parameters of the tip prediction computer model. In one or more embodiments, the online concierge system 140 collects (e.g., via the machine-learning training module 230) feedback data from the picker with information about a sentiment of the picker in relation to a tip amount provided by the user, i.e., information on whether the picker believes the tip amount reflected their effort in fulfilling the order. The online concierge system 140 may re-train (e.g., via the machine-learning training module 230) the tip prediction computer model by updating, using the collected feedback data with information about the picker's sentiment in relation to the tip amount, the set of parameters of the tip prediction computer model.

Embodiments of the present disclosure are directed to the online concierge system 140 that uses a trained computer model to generate a post-delivery effort-based tip increase recommendation for a user of the online concierge system 140. The trained computer model provides the post-delivery effort-based tip increase recommendation based on input features that describe the fulfillment process and relate to the picker's effort to fulfill an order. The input features for the trained computer model are obtained after the fulfillment process has occurred or at least until after a phase of the fulfillment process from which the input features are obtained has been completed.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
obtaining order data with information about an order placed by a user of an online system;
gathering fulfillment data describing a fulfillment process for the order;
accessing a tip prediction computer model of the online system, wherein the tip prediction computer model is trained to predict a tip amount that is likely to lead to satisfaction of a picker associated with the online system who fulfilled the order;
applying the tip prediction computer model to predict, based on the order data and the fulfillment data, the tip amount;
identifying information about a sentiment of the user in relation to the fulfillment process;
receiving information about an original tip amount the user provided for fulfilling the order before the fulfillment process for the order was completed;
responsive to the information about the sentiment of the user, generating, based on the predicted tip amount and the original tip amount, a tip adjustment amount; and
causing a user interface of a device associated with the user to display the tip adjustment amount prompting the user to adjust the original tip amount to at least the predicted tip amount.

2. The method of claim 1, wherein obtaining the order data comprises:
receiving, from the device associated with the user via a network, information about a set of items that were originally ordered by the user.

3. The method of claim 1, wherein gathering the fulfillment data comprises:
receiving, from a device associated with the picker via a network, at least one of a set of features for a set of items picked by the picker at a location of a retailer associated with the online system, information about a time the picker spent on checking-out at the location of the retailer, or information about an effort made by the picker during a drop-off phase of the fulfillment process.

4. The method of claim 1, wherein gathering the fulfillment data comprises:
receiving, via a network, at least one of information about a traffic during delivery of the order to a delivery location of the user, or information about a weather event during delivery of the order to the delivery location.

5. The method of claim 4, wherein gathering the fulfillment data comprises:
receiving, from at least one of the device associated with the user or the device associated with the picker via the network, at least one of information about a number of items from an original set of items associated with the order that were replaced during the fulfillment process, information about a new items that were added to the order during the fulfillment process, or communication data exchanged between the device associated with the user and the device associated with the picker during the fulfillment process.

6. The method of claim 1, further comprising:
gathering information about a set of tip adjustment amounts for a set of orders placed at the online system during a defined time period;
gathering information about sentiments of a group of pickers associated with the online system in relation to the set of tip adjustment amounts;
generating training data using the information about the set of tip adjustment amounts and the information about sentiments; and
training the tip prediction computer model using the generated training data to generate an initial set of parameters of the tip prediction computer model.

7. The method of claim 1, further comprising:
gathering training data by surveying a group of pickers associated with the online system about a set of tip amounts for a set of fulfillment processes associated with a set of orders placed at the online system; and
training the tip prediction computer model using the gathered training data to generate an initial set of parameters of the tip prediction computer model.

8. The method of claim 1, further comprising:
collecting feedback data with information about a response by the user in relation to the tip adjustment amount that is displayed at the user interface of the device associated with the user; and
re-training the tip prediction computer model by updating, using the collected feedback data, a set of parameters of the tip prediction computer model.

9. The method of claim 1, wherein identifying the information about the sentiment of the user in relation to the fulfillment process comprises:
causing the user interface of the device associated with the user to display a message prompting the user to provide feedback with information about a level of satisfaction by the user in relation to the fulfillment process; and
identifying, based on the information about the level of satisfaction, the information about the sentiment of the user in relation to the fulfillment process.

10. The method of claim 1, wherein displaying the user interface further comprises:
generating, based on the order data and the fulfillment data, a message explaining an effort made by the picker during the fulfillment process; and
causing the user interface of the device associated with the user to further display the generated message along with the tip adjustment amount.

11. A computer program product comprising a non-transitory computer readable storage medium having instructions encoded thereon that, when executed by a processor, cause the processor to perform steps comprising:
obtaining order data with information about an order placed by a user of an online system;
gathering fulfillment data describing a fulfillment process for the order;
accessing a tip prediction computer model of the online system, wherein the tip prediction computer model is trained to predict a tip amount that is likely to lead to satisfaction of a picker associated with the online system who fulfilled the order;
applying the tip prediction computer model to predict, based on the order data and the fulfillment data, the tip amount;
identifying information about a sentiment of the user in relation to the fulfillment process;
receiving information about an original tip amount the user provided for fulfilling the order before the fulfillment process for the order was completed;
responsive to the information about the sentiment of the user, generating, based on the predicted tip amount and the original tip amount, a tip adjustment amount; and
causing a user interface of a device associated with the user to display the tip adjustment amount prompting the user to adjust the original tip amount to at least the predicted tip amount.

12. The computer program product of claim 11, wherein the instructions further cause the processor to perform steps comprising:
gathering the fulfillment data by receiving, from a device associated with the picker via a network, at least one of a set of features for a set of items picked by the picker at a location of a retailer associated with the online system, information about a time the picker spent on checking-out at the location of the retailer, or information about an effort made by the picker during a drop-off phase of the fulfillment process.

13. The computer program product of claim 11, wherein the instructions further cause the processor to perform steps comprising:
gathering the fulfillment data by receiving, via a network, at least one of information about a traffic during delivery of the order to a delivery location of the user, or information about a weather event during delivery of the order to the delivery location.

14. The computer program product of claim 13, wherein the instructions further cause the processor to perform steps comprising:
gathering the fulfillment data by receiving, from at least one of the device associated with the user or the device associated with the picker via the network, at least one of information about a number of items from an original set of items associated with the order that were replaced during the fulfillment process, information about a new items that were added to the order during the fulfillment process, or communication data exchanged between the device associated with the user and the device associated with the picker during the fulfillment process.

15. The computer program product of claim 11, wherein the instructions further cause the processor to perform steps comprising:
gathering information about a set of tip adjustment amounts for a set of orders placed at the online system during a defined time period;
gathering information about sentiments of a group of pickers associated with the online system in relation to the set of tip adjustment amounts;
generating training data using the information about the set of tip adjustment amounts and the information about sentiments; and
training the tip prediction computer model using the generated training data to generate an initial set of parameters of the tip prediction computer model.

16. The computer program product of claim 11, wherein the instructions further cause the processor to perform steps comprising:
gathering training data by surveying a group of pickers associated with the online system about a set of tip amounts for a set of fulfillment processes associated with a set of orders placed at the online system; and
training the tip prediction computer model using the gathered training data to generate an initial set of parameters of the tip prediction computer model.

17. The computer program product of claim 11, wherein the instructions further cause the processor to perform steps comprising:
collecting feedback data with information about a response by the user in relation to the tip adjustment amount that is displayed at the user interface of the device associated with the user; and
re-training the tip prediction computer model by updating, using the collected feedback data, a set of parameters of the tip prediction computer model.

18. The computer program product of claim 11, wherein the instructions further cause the processor to perform steps comprising:
causing the user interface of the device associated with the user to display a message prompting the user to provide feedback with information about a level of satisfaction by the user in relation to the fulfillment process; and
identifying, based on the information about the level of satisfaction, the information about the sentiment of the user in relation to the fulfillment process.

19. The computer program product of claim 11, wherein the instructions further cause the processor to perform steps comprising:
generating, based on the order data and the fulfillment data, a message explaining an effort made by the picker during the fulfillment process; and
causing the user interface of the device associated with the user to further display the generated message along with the tip adjustment amount.

20. A computer system comprising:
a processor; and
a non-transitory computer-readable storage medium having instructions that, when executed by the processor, cause the computer system to perform steps comprising:
obtaining order data with information about an order placed by a user of an online system;
gathering fulfillment data describing a fulfillment process for the order;
accessing a tip prediction computer model of the online system, wherein the tip prediction computer model is trained to predict a tip amount that is likely to lead to satisfaction of a picker associated with the online system who fulfilled the order;
applying the tip prediction computer model to predict, based on the order data and the fulfillment data, the tip amount;
identifying information about a sentiment of the user in relation to the fulfillment process;
receiving information about an original tip amount the user provided for fulfilling the order before the fulfillment process for the order was completed;
responsive to the information about the sentiment of the user, generating, based on the predicted tip amount and the original tip amount, a tip adjustment amount; and
causing a user interface of a device associated with the user to display the tip adjustment amount prompting the user to adjust the original tip amount to at least the predicted tip amount.
